(19) United States
(12) Patent Application Publication
(10) Pub. No.: US 2023/0014294 A1
(43) Pub. Date: Jan. 19, 2023

(54) LASER RECORDING DEVICE

(71) Applicants: KABUSHIKI KAISHA TOSHIBA, Tokyo (JP); Toshiba Infrastructure Systems & Solutions Corporation, Kawasaki-shi (JP)

(72) Inventors: Nobuki NEMOTO, Kawasaki Kanagawa (JP); Yuuichi NAKAMURA, Tokyo (JP); Yuuma KADOKURA, Yuuma (JP); Naoto MIHARA, Yokohama Kanagawa (JP)

(73) Assignees: KABUSHIKI KAISHA TOSHIBA, Tokyo (JP); Toshiba Infrastructure Systems & Solutions Corporation, Kawasaki-shi KanagawA (JP)

(21) Appl. No.: 17/934,535

(22) Filed: Sep. 22, 2022

Related U.S. Application Data
(63) Continuation of application No. PCT/JP2021/011729, filed on Mar. 22, 2021.

(30) Foreign Application Priority Data
Mar. 24, 2020 (JP) 2020-053195

(51) Int. Cl. B41J 2/455; B41J 2/44; B41J 2/475

(52) U.S. Cl. CPC B41J 2/455; B41J 2/442; B41J 2/4753; B41M 5/34

(57) ABSTRACT

A laser recording device of an embodiment is for a thermal recording medium in which at least one color development layer developing a color through heat and a protective layer protecting recorded information obtained through color development of the at least one color development layer are laminated, and has light transmission properties before recording. The laser recording device includes a recording head in which emitters emitting laser light from laser light sources are arranged, and a recording controller performing parallel processing of control for causing the laser light sources to emit light independently of each other and guiding the laser light from the emitters to the thermal recording medium.

### CROSS REFERENCE TO RELATED APPLICATIONS

This application is a Continuation Application of PCT Application No. PCT/JP2021/011729, filed Mar. 22, 2021 and based upon and claiming the benefit of priority from Japanese Patent Application No. 2020-053195, filed Mar. 24, 2020, the entire contents of all of which are incorporated herein by reference.

### FIELD

Embodiments described herein relate generally to a laser recording device.

### BACKGROUND

Conventionally, there are mainly two methods for performing full-color recording with lasers.

The first method is for applying energy with lasers to a laminated medium of three-primary-color color development layers having different threshold temperatures for selective color development of the three-primary-color development layers.

The second method employs lasers with three different wavelengths for three-primary-color layers having absorption characteristics at different wavelengths to record the colors.

For example, a method, in which full-color recording is completed by causing a multilayer element including at least one layer of a laser-sensitive material to absorb laser light for color development or decoloring to record each color, is known.

### BRIEF DESCRIPTION OF THE DRAWINGS

FIG. 1 is an external front view of a thermal recording medium used for a laser recording device according to an embodiment in a state in which information is recorded.

FIG. 2 is a cross-sectional view of a configuration example of the thermal recording medium.

FIG. 3 is an explanatory diagram of a thickness and a thermal conductivity ratio of the thermal recording medium.

FIG. 4 is an explanatory diagram of an example of light absorption characteristics of a photothermal conversion layer.

FIG. 5 is a schematic configuration block diagram of a laser recording device.

FIG. 6 is an operation process flowchart of the laser recording device.

FIG. 7 shows a front view and a top view of a configuration example of a recording head in the laser recording device.

FIG. 8 is an explanatory diagram of a relationship between an emission pitch of the recording head and a recording resolution in a laser light source unit.

FIG. 9 shows a front view and a top view of a modification of the recording head.

FIG. 10 is an explanatory diagram of a function of a recording controller for the recording head of the laser recording device.

FIG. 11 is a cross-sectional view of a configuration example of a thermal recording medium in which the light-absorption color development layer is omitted.

FIG. 12 is a cross-sectional view of another configuration example of a thermal recording medium in which the light-absorption color development layer is omitted.

### DETAILED DESCRIPTION

A laser recording device of an embodiment is for a thermal recording medium in which at least one color development layer developing a color through heat and a protective layer protecting recorded information obtained through color development of the at least one color development layer are laminated, and has light transmission properties before recording. The laser recording device includes a recording head in which emitters emitting laser light from laser light sources are arranged, and a recording controller performing parallel processing of control for causing the laser light sources to emit light independently of each other and guiding the laser light from the emitters to the thermal recording medium.

Hereinafter, embodiments will be described in detail with reference to the drawings.

### One Embodiment

First, a thermal recording medium (anti-forgery medium) 10 used for a laser recording device of one embodiment will be described.

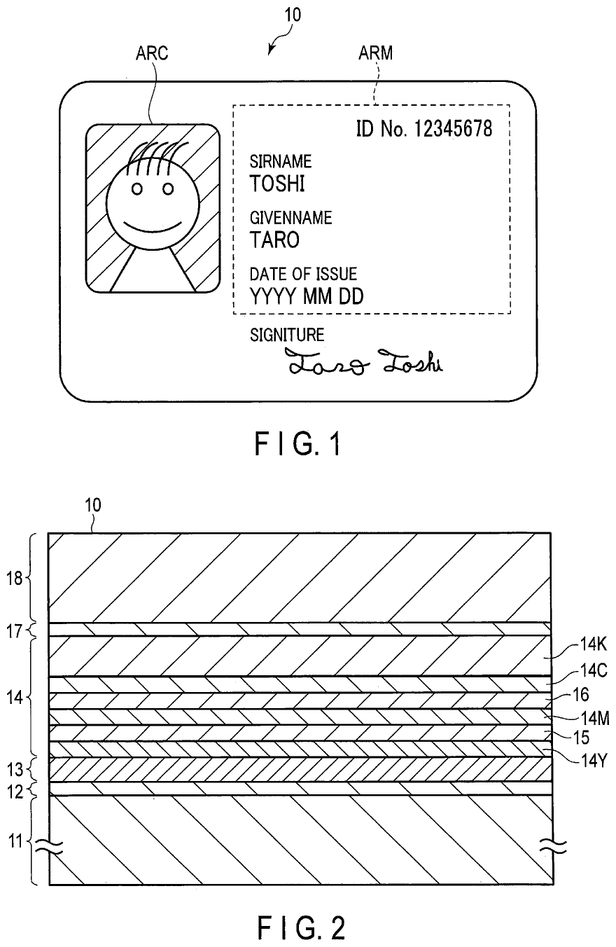

FIG. 1 is an external front view of the thermal recording medium 10 in a state in which information is recorded.

The thermal recording medium 10 on which information is recorded mainly includes a full-color image forming area ARC in which a full-color image such as an identification photograph is recorded, and a monochrome image forming area ARM in which specific information such as ID information, a name, and an issue date is recorded in monochrome.

FIG. 2 is a cross-sectional view of a configuration example of the thermal recording medium 10.

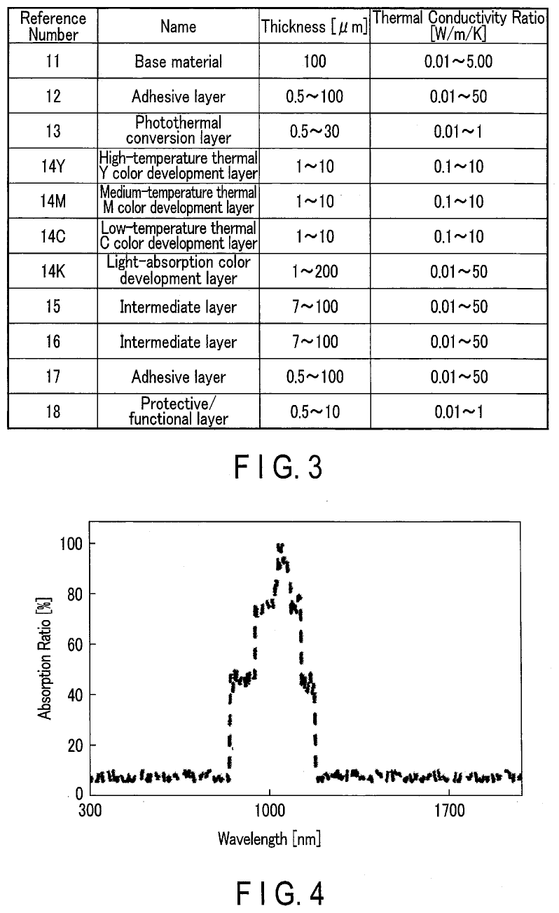

FIG. 3 is an explanatory diagram of a thickness and a thermal conductivity ratio of the thermal recording medium 10.

The thermal recording medium 10 is a recording medium in which at least one color development layer that develops a color through heat and a protective layer that protects recorded information obtained through color development of the at least one color development layer are laminated. The recording medium has light transmission properties before recording.

As a specific example, the thermal recording medium 10 has a structure in which, as shown in FIG. 1, an adhesive layer 12, a photothermal conversion layer 13, a high-temperature thermal Y (yellow) color development layer 14Y, an intermediate layer 15, a medium-temperature thermal M (magenta) color development layer 14M, an intermediate layer 16, a low-temperature thermal C (cyan) color development layer 14C, a light-absorption color development layer 14K, an adhesive layer 17, and a protective/functional layer 18 are laminated in this order on a base material 11. The light-absorption color development layer 14K is provided as a black (K) color development layer. The color development layers 14Y, 14M, 14C, and 14K constitute a color development layer group 14. If the color development layers 14Y, 14M, and 14C are mixed to develop black, the light-absorption color development layer 14K may be omitted.

The color development layers 14Y, 14M, and 14C function as thermal recording layers for recording an image with three primary colors of yellow, magenta and cyan.

The intermediate layers 15 and 16 each function as a heat insulating layer that adjusts the amount of heat transfer and reduces heat transfer.

The base material 11 holds the adhesive layer 12, the photothermal conversion layer 13, the high-temperature thermal Y color development layer 14Y, the intermediate layer 15, the medium-temperature thermal M color development layer 14M, the intermediate layer 16, the low-temperature thermal C color development layer 14C, the light-absorption color development layer 14K, the adhesive layer 17, and the protective/functional layer 18.

The thickness of the base material 11 is set to 100 μm, and the thermal conductivity ratio thereof is set to 0.01 to 5.00 W/m/K, for example.

The photothermal conversion layer 13 is a layer that absorbs recording light of a given wavelength (recording laser light) and performs light/heat conversion to generate heat for causing at least any one of the color development layer 14Y, 14M or 14C to develop a color and transfer the heat.

The thickness of the photothermal conversion layer 13 is set to 0.5 to 30 μm, and the thermal conductivity ratio thereof is set to 0.01 to 50 W/m/K, for example.

The adhesive layer 12 is a layer that holds the base material 11 and the photothermal conversion layer 13 while bonding them.

The thickness of the adhesive layer 12 is set to 0.5 to 100 μm, and the thermal conductivity ratio thereof is set to 0.01 to 50 W/m/K, for example.

The color development layer 14Y is a layer containing a temperature indicating material as a thermal material that develops a color if its temperature becomes equal to or higher than a first threshold temperature T1.

The thickness of the color development layer 14Y is set to 1 to 10 μm, and the thermal conductivity ratio thereof is set to 0.01 to 10 W/m/K, for example.

The color development layer 14M is a layer containing a temperature indicating material as a thermal material that develops a color if its temperature becomes equal to or higher than a second threshold temperature T2 (<T1).

The thickness of the color development layer 14M is set to 1 to 10 μm, and the thermal conductivity ratio thereof is set to 0.1 to 10 W/m/K, for example.

The color development layer 14C is a layer containing a temperature indicating material as a thermal material that develops a color if its temperature becomes equal to or higher than a second threshold temperature T3 (<T2<T1).

The thickness of the color development layer 14C is set to 1 to 10 μm, and the thermal conductivity ratio thereof is set to 0.1 to 10 W/m/K, for example.

The intermediate layer 15 is a layer that provides a thermal barrier at the time of color development of the color development layer 14Y and reduces heat transfer from the color development layer 14C side to the color development layers 14M and 14C.

The thickness of the intermediate layer 15 is set to 7 to 100 μm, and the thermal conductivity ratio thereof is set to 0.01 to 50 W/m/K, for example.

The intermediate layer 16 is a layer that provides a thermal barrier at the time of color development of the color development layer 14M and reduces heat transfer from the color development layer 14M side to the color development layer 14C.

The thickness of the intermediate layer 16 is set to 7 to 100 μm, and the thermal conductivity ratio thereof is set to 0.01 to 50 W/m/K, for example.

The light-absorption color development layer 14K is a layer including pigment particles in which pigment particles undergo irreversible development by carbonization after absorbing laser light as the recording light.

The thickness of the light-absorption color development layer 14K is set to 1 to 200 μm, and the thermal conductivity ratio thereof is set to 0.01 to 50 W/m/K, for example.

The adhesive layer 17 is a layer that holds the light-absorption color development layer 14K and the protective/functional layer 18 while bonding them.

The thickness of the adhesive layer 17 is set to 0.5 to 100 μm, and the thermal conductivity ratio thereof is set to 0.01 to 50 W/m/K, for example.

The protective/functional layer 18 is a layer that protects the adhesive layer 17, the light-absorption color development layer 14K, the color development layer 14C, the intermediate layer 16, the color development layer 14M, the intermediate layer 15, the color development layer 14Y, the photothermal conversion layer 13, and the adhesive layer 12, and is provided for use of arrangement of anti-counterfeit items such as a hologram, a lenticular lens, a microarray lens, or an ultraviolet excitation type fluorescent ink, insertion of an internal protection item such as an ultraviolet cut layer, or both of these functions, etc.

The thickness of the protective/functional layer 18 is set to 0.5 to 10 μm, and the thermal conductivity ratio thereof is set to 0.01 to 1 W/m/K, for example.

FIG. 4 is an explanatory diagram of an example of light absorption characteristics of the photothermal conversion layer.

As shown in FIG. 4, the photothermal conversion layer 13 has absorption characteristics having an absorption peak at a wavelength A (for example, λ=1064 nm) belonging to near-infrared rays.

Meanwhile, the adhesive layer 12, the color development layer 14Y, the intermediate layer 15, the color development layer 14M, the intermediate layer 16, the color development layer 14C, the adhesive layer 17, and the protective/functional layer 18 are each formed of a material that transmits light having a wavelength A belonging to near-infrared rays (near-infrared light). At least a part of the base material 11 is formed of a material that transmits near-infrared light. This is because light having a wavelength A that can be absorbed by the light-absorption color development layer 14K or the photothermal conversion layer 13 (near-infrared light) is made to reach these layers.

Therefore, if near-infrared light having a wavelength λ (for example, λ=1064 nm) is incident from the base material 11 side, in the full-color image forming area ARC, the incident near-infrared light is transmitted through the respective layers in order from the base material 11 to the adhesive layer 12, and mostly absorbed and photo-thermally converted by the photothermal conversion layer 13, causing the color development layer 14Y, 14M or 14C to develop a color.

On the other hand, in the monochrome image forming area ARM, the light is transmitted through the respective layers in order from the protective/functional layer 18 to the adhesive layer 17, and mostly absorbed and photo-thermally converted by the light-absorption color development layer 14K, causing the light-absorption color development layer 14K to develop a color.

The protective/functional layer 18 may be provided as necessary, and as a specific function, may be used for insertion of anti-counterfeit items such as a hologram, a lenticular lens, a microarray lens, or an ultraviolet excitation type fluorescent ink, insertion of an internal protection item such as an ultraviolet cut layer, or both of these functions, etc. The protective functional layer 18 is preferably colorless and transparent since there is a need to visually check the color recording or monochrome recording recorded under the protective/functional layer 18 after completion of recording.

In the example of the thermal recording medium 10, the high-temperature thermal Y color development layer 14Y and the photothermal conversion layer 13 are laminated as independent layers. As another example, by mixing one kind of photothermal conversion material into the high-temperature thermal Y color development layer 14Y, the high-temperature thermal Y color development layer 14Y may serve as the photothermal conversion layer.

Next, a laser recording device according to one embodiment will be described.

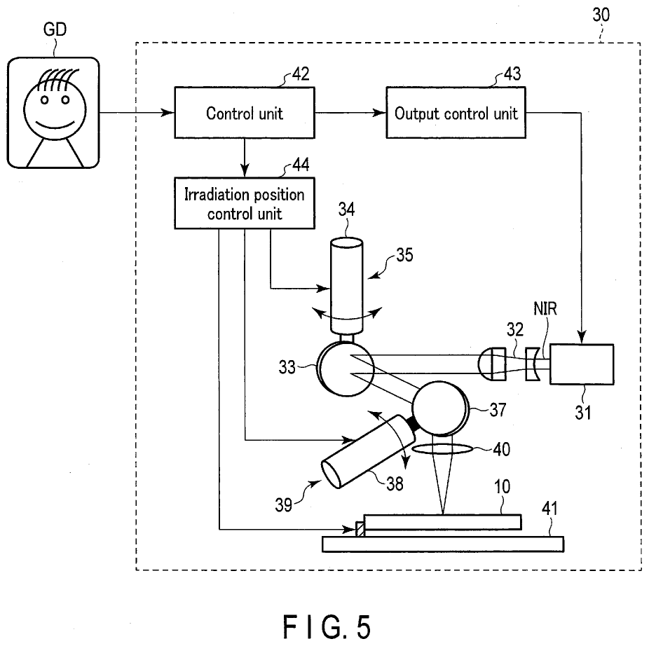

FIG. 5 is a schematic configuration block diagram of a laser recording device according to one embodiment.

A laser recording device 30 of one embodiment includes at least: a laser light source unit 31 that outputs near-infrared laser light NIR (=wavelength λ); a beam expander 32 that expands the beam diameter of the near-infrared laser light NIR; a first-direction scanning unit 35 including a first motor 34 that drives a first-direction scan mirror 33 reflecting the near-infrared laser light NIR, and drives the first-direction scan mirror 33 for scanning the near-infrared laser light NIR in a first direction; a second-direction scanning unit 39 including a second motor 38 that drives a second-direction scan mirror 37 reflecting the near-infrared laser light NIR, and drives a second-direction scan mirror 37 for scanning the near-infrared laser light NIR in a second direction orthogonal to the first direction; a condenser lens (F θ lens) 40 that condenses the near-infrared laser light NIR guided through the first-direction scanning unit 35 and the second-direction scanning unit 39 to the thermal recording medium 10; a stage 41 that conveys the thermal recording medium 10 to a given position and retains it; a control unit 42 that calculates the irradiation position and irradiation intensity of far-infrared laser light LFIR based on the input image data GD and controls the entire laser recording device 30; an output control unit 43 that controls laser output of the laser light source unit 31 based on the calculation result of the control unit 42; and an irradiation position control unit 44 that controls the first motor 34 and the second motor 38 based on the calculation result of the control unit 42 and controls the irradiation position of the near-infrared laser light NIR on the thermal recording medium 10.

In the above configuration, examples of the laser light source unit 31 include near-infrared region lasers such as a semiconductor laser, a fiber laser, a YAG laser, or a YVO₄ laser.

Next, a process of recording on the thermal recording medium 10 by the laser recording device 30 will be described.

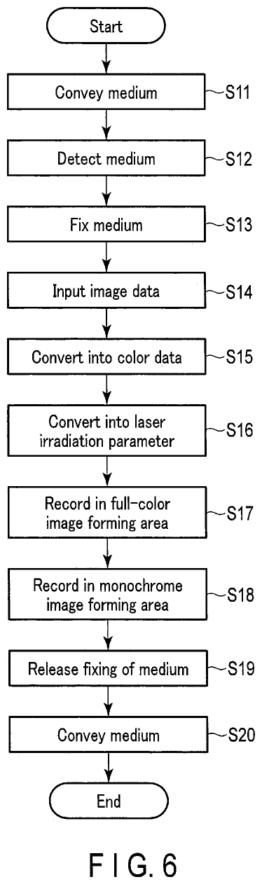

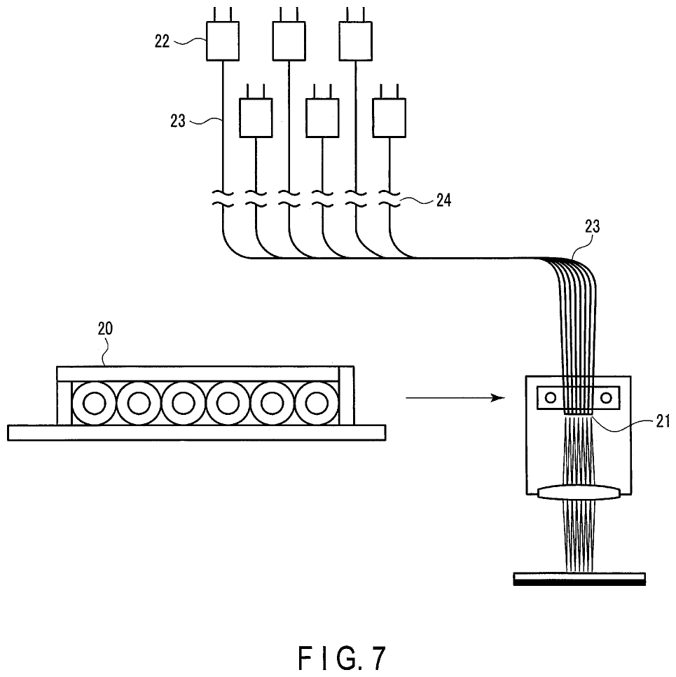

FIG. 6 is an operation process flowchart related to the laser recording device.

First, the control unit 42 of the laser recording device 30 conveys the thermal recording medium 10 to a recording position via a conveyance device (not shown) (step S11).

Subsequently, the control unit 42 of the laser recording device 30 detects the conveyed thermal recording medium 10 through a sensor (not shown) (step S12), and fixes the thermal recording medium 10 through a fixing device (not shown) at a predetermined conveyance position (step S13).

Subsequently, upon input of input image data GD as RGB data (step S14), the control unit 42 of the laser recording device 30 analyzes the input image data GD, and converts it into color data (CMYK data) for each pixel (step S15).

Subsequently, the control unit 42 converts the color data into a laser irradiation parameter value in accordance with a combination of layers to develop colors based on the color data for each pixel (step S16).

Here, the laser irradiation parameter value is specifically a power setting value, a scanning speed setting value, a pulse width setting value, an irradiation repetition number setting value, a scanning pitch setting value, or the like.

Subsequently, the control unit 42 controls the output control unit 43 and the irradiation position control unit 44, and causes the high-temperature thermal Y color development layer 14Y, the medium-temperature thermal M color development layer 14M and the low-temperature thermal C color development layer 14C to develop colors using the near-infrared laser beam NIR based on the laser irradiation parameter value set in step S16, and performs image recording on the full-color image forming area ARC (step S17).

Here, color development control in the full-color image forming area ARC will be described.

In the full-color image forming area ARC, the laser recording device 30 performs color development using the high-temperature thermal Y color development layer 14Y, the medium-temperature thermal M color development layer 14M, and the low-temperature thermal C color development layer 14C.

As described above, the high-temperature thermal Y color development layer 14Y develops a color if its temperature is equal to or higher than the first threshold temperature T1, the medium-temperature thermal M color development layer 14M develops a color if its temperature is equal to or higher than the second threshold temperature T2 (<T1), and the low-temperature thermal C color development layer 14C develops a color if its temperature is equal to or higher than the third threshold temperature T3 (<T2<T1).

More specifically, for example, the first threshold temperature T1 corresponding to the high-temperature thermal Y color development layer 14Y is set to 150 to 270° C., the second threshold temperature T2 corresponding to the medium-temperature thermal M color development layer 14M is set to 100 to 200° C., and the third threshold temperature T3 corresponding to the low-temperature thermal C color development layer 14C is set to 60 to 140° C. so as to satisfy the above relationship.

Next, color development control in the monochrome image forming area ARM will be described.

Upon termination of recording in the full-color image forming area ARC, the control unit 42 controls the output control unit 43 and the irradiation position control unit 44, and causes the light-absorption color development layer 14K to develop a color using the near-infrared laser light NIR based on the laser irradiation parameter value set in step S16.

Subsequently, the control unit 42 of the laser recording device 30 releases the fixing of the recording medium 10 made by the fixing device (not shown) (step S19), conveys the recording medium 10 to a predetermined conveyance position via the conveyance device (not shown), and ends the processing (step S20).

As described above, according to one embodiment, full-color/monochrome image recording can be performed using a laser light source of a single wavelength. Furthermore, according to one embodiment, additional writing cannot be performed using a thermal head or the like, the falsification of the recording medium can be prevented, and security can be improved.

Next, the configuration of the laser light source unit 31 will be further described.

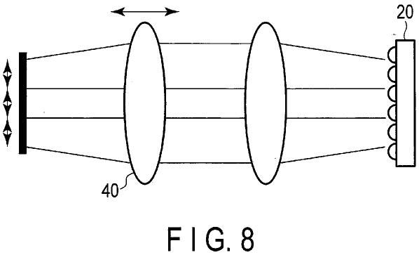

FIG. 7 shows a front view and a top view of a configuration example of a laser light source unit in the laser recording device.

The laser light source unit 31 includes a recording head 20 as shown in FIG. 7. As an example, the recording head 20 includes, as a multi-laser light source (LD) head, a plurality of emitters 21 and a plurality of laser light sources 22. The plurality of emitters 21 are arrayed to be aligned in a row. The plurality of emitters 21 and the plurality of laser light sources 22 are connected via a plurality of optical fibers 23. A plurality of connectors 24 are inserted at middle parts of the plurality of optical fibers 23. The plurality of emitters 21 respectively emit laser light from the plurality of laser light sources 22. In the plurality of emitters 21, ends of the optical fibers 23 protrude from emission ports. In FIG. 7, six emitters 21, six laser light sources 22, six optical fibers 23, and six connectors 24 are provided.

In this structure, four of the six laser light sources 22 are Y/M/C/K color development laser light sources (LDs) assigned respectively to the color development layers 14Y, 14M, 14C, and 14K. The remaining two laser light sources are a laser light source (LD) for preheating the thermal recording medium 10, and a visible light laser light source (LD) for an irradiation start position marker. As for the Y/M/C color development laser light sources, it is preferable that the power ratios for high temperature, medium temperature, and low temperature (PH: PM: PL) be controlled in the ranges of 100 to 50: 70 to 10: 50 to 1 and that the relationship of PH≥PM≥PL be maintained.

FIG. 8 is an explanatory diagram of a relationship between an emission pitch of the recording head and a recording resolution in the laser light source unit. The emission pitch of the plurality of emitters 21 is set to an integer multiple (N) of the recording resolution pitch. The recording resolution can be adjusted by moving the lens 40 as shown in FIG. 8 to change an optical magnification.

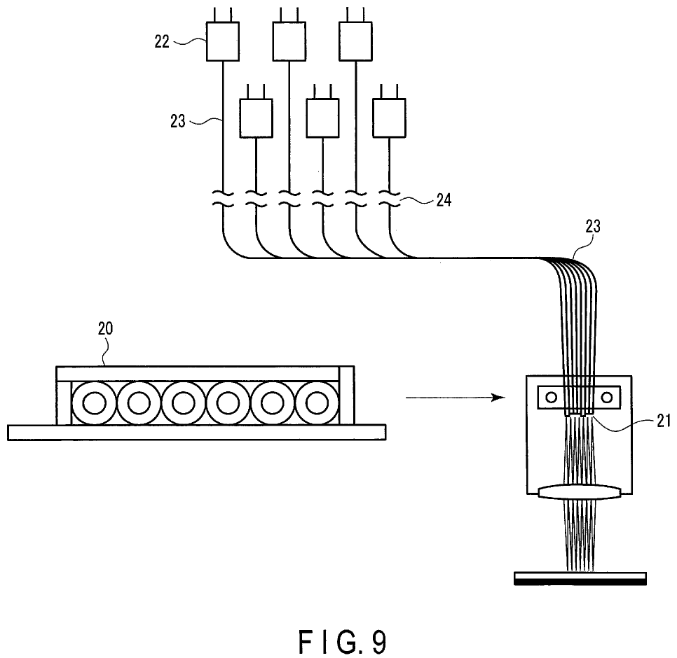

FIG. 9 shows a front view and a top view of a modification of the recording head 20. Here, the recording head 20 has a structure in which in some of the plurality of emitters 21, the fiber ends protrude. With this structure, it is possible to obtain spot diameters different for respective color development layers of cyan, magenta, and yellow, by changing the optical magnification in the optical system at a subsequent stage. In particular, it is effective for obtaining a spot diameter widened to be suitable for a color development layer having a low color development temperature.

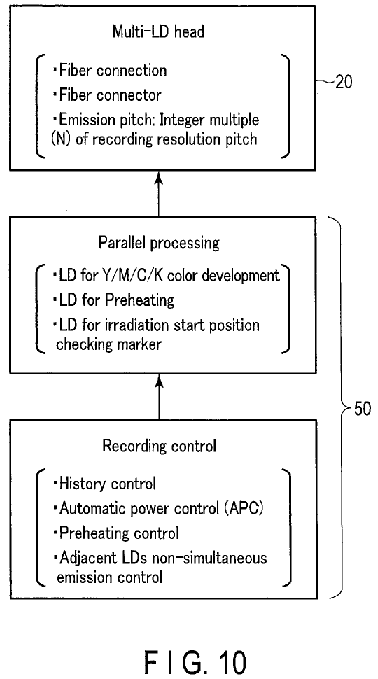

FIG. 10 is an explanatory diagram for functions of a recording controller 50 for the recording head 20 of the laser recording device 30. The recording controller 50 includes the control unit 42, the output control unit 43, and the irradiation position control unit 44, and further includes an optical system that guides laser light from the laser light source unit 31 to the thermal recording medium 10, and a magnification changing mechanism that changes an optical magnification of the optical system.

The recording controller 50 is configured to perform different recording control on the six laser light sources 22 depending on purposes. The recording control includes setting the Y/M/C/K color development laser light sources 22 to different rated outputs for the respective color development layers assigned. The recording control includes changing the spot diameters of the laser light from the Y/M/C/K color development laser light sources 22 for the respective color development layers assigned. Thereby, the color development time of cyan can be shortened. The recording control includes, as history control, changing an output of the laser light source 22 and an irradiation time in accordance with pixel data of an adjacent point. The recording control includes performing automatic power control by capturing and feeding back the laser light emitted from each laser light source 22. The recording control includes irradiating the thermal recording medium 10 with laser light from the preheating laser light source 22 prior to laser light irradiation from the Y/M/C/K color development laser light sources 22 for recording information on the thermal recording medium 10. The laser light irradiation for preheating is performed with a spot diameter larger than that of laser light irradiation for recording information, by bringing the preheating laser light source 22 close to the lens. The recording control includes marking the irradiation start position with the laser light from the visible light laser light source 22. The recording control includes changing the control parameter based on recording data of a plurality of pixels arranged before and after the recording pixel. The recording control includes controlling the plurality of laser light sources 22 so as not to simultaneously emit laser light from adjacent emitters among the plurality of emitters 21. Thereby, the influence of heat accumulation is reduced.

In such a laser recording device of one embodiment, laser beams from the plurality of laser light sources 22 having different purposes can be applied to the thermal recording medium 10 independently and in parallel. Therefore, it is possible to speed up color image recording while suppressing the cost with a simplified configuration.

In the above description, the laser beams having the same wavelength (λ=1064 nm) are applied to the photothermal conversion layer 13 and the light-absorption color development layer 14K from the base material 11 side and the protective/functional layer 18 side, respectively, for recording.

On the other hand, laser beams having different wavelengths may be used so that the absorption spectrum characteristics of the photothermal conversion layer 13 and the light-absorption color development layer 14K may be made different. In this case, the absorption spectrum characteristics of the photothermal conversion layer 13 are set so that the laser light absorption peak is λ=800 nm, for example, and the absorption spectrum characteristics of the light-absorption color development layer 14K are set so that the laser light absorption peak is λ=1064 nm. Furthermore, since the laser light having the wavelength λ=800 nm travels toward the photothermal conversion layer 13 through the light-absorption color development layer 14K close to the protective/functional layer 18, it is necessary to use a material that transmits laser light having the wavelength (λ=800 nm) for the light-absorption color development layer 14K. Thereby, the laser beams having different wavelengths can be emitted from the protective/functional layer 18 side. In this case, the base material 11 does not need to be transparent to visible light or near-infrared light.

The positional relationship between the photothermal conversion layer 13 and the light-absorption color development layer 14K may be opposite. In this case, since the laser light having the wavelength λ=1064 nm travels toward the light-absorption color development layer 14K through the photothermal conversion layer 13 close to the protective/functional layer 18, it is necessary to use a material that transmits laser light having the wavelength (λ=1064 nm) for the photothermal conversion layer 13. Thereby, the laser beams having different wavelengths can be emitted from the protective/functional layer 18 side. In this case, the base material 11 does not need to be transparent to visible light or near-infrared light.

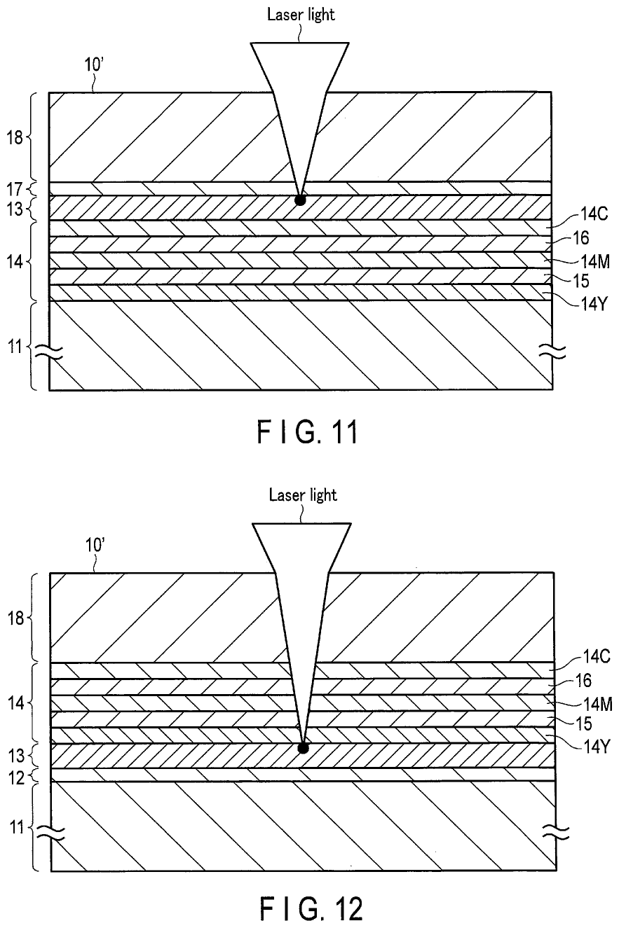

FIG. 11 is a cross-sectional view of a configuration example of a thermal recording medium in which the light-absorption color development layer is omitted. FIG. 12 is a cross-sectional view of another configuration example of a thermal recording medium in which the light-absorption color development layer is omitted. In FIG. 11, the photothermal conversion layer 13 is disposed in the vicinity of the protective/functional layer 18, and the color development layer group 14 is disposed between the photothermal conversion layer 13 and the base material 11. In FIG. 12, the color development layer group 14 is disposed in the vicinity of the protective/functional layer 18, and the photothermal conversion layer 13 is disposed between the color development layer group 14 and the base material 11. Even in the configuration examples shown in FIGS. 11 and 12, the base material 11 does not need to be transparent to visible light or near-infrared light.

In the above description, the plurality of emitters 21 of the recording head 20 are linearly arranged in one line, but may be linearly arranged in a plurality of lines or arranged in a staggered shape (a screen angle of 45 degrees, a screen angle of 30 degrees, or an arbitrary screen angle of 10 to 45 degrees).

In the above description, near-infrared laser light is used as the color development laser light, but near-ultraviolet laser light or far-ultraviolet laser light may be used as the laser light depending on the absorption wavelength of the photothermal conversion layer.

In the above description, the independent control unit 42, output control unit 43, and irradiation position control unit 44 are used as a part of the recording controller 50, but they may be configured as a computer including an MPU, ROM, RAM, etc. and their functions may be executed via programs and various interfaces.

In this case, the program executed by the computer may be recorded on a computer-readable recording medium in an installable or executable file format such as a semiconductor recording device such as a CD-ROM, a digital versatile disk (DVD), or a USB memory.

In addition, a program executed by a computer may be stored and provided in a computer connected to a network such as the Internet by being downloaded via the network. The program executed by the control unit 52 may be provided or distributed via a network such as the Internet.

A program executed by a computer may be incorporated in advance in a ROM.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A laser recording device for a thermal recording medium comprising a laminate of at least one color development layer that develops a color through heat and a protective layer that protects recorded information obtained through color development of the at least one color development layer,
the laser recording device comprising:
a recording head comprising a plurality of emitters arranged, the emitters being configured to emit laser light from a plurality of laser light sources; and
a recording controller configured to perform parallel processing of control for causing the laser light sources to emit light independently of each other and guide the laser light from the emitters to the thermal recording medium.

2. The laser recording device according to claim 1, wherein the thermal recording medium comprises, as the at least one color development layer, three-primary-color color development layers laminated separately for each color.

3. The laser recording device according to claim 2, wherein the thermal recording medium further comprises a photothermal conversion layer laminated on the three-primary-color color development layers and containing one kind of photothermal conversion material,
the three-primary-color color development layers having different color development thresholds and being disposed such that a layer of the three-primary-color color development layers having a higher color development threshold temperature is closer to the photothermal conversion layer.

4. The laser recording device according to claim 2, wherein in the thermal recording medium, one of the three-primary-color color development layers having a highest color development threshold serves as a photothermal conversion layer containing one kind of photothermal conversion material.

5. The laser recording device according to claim 1, wherein the laser light sources and the emitters are connected via a plurality of optical fibers, respectively.

6. The laser recording device according to claim 5, wherein the recording head comprises a plurality of connectors inserted at respective middle parts of the optical fibers to connect the laser light sources and the emitters.

7. The laser recording device according to claim 1, wherein the emitters are arranged at an emission pitch corresponding to an integer (N) multiple of a recording resolution.

8. The laser recording device according to claim 1, wherein the recording controller is configured to perform different recording control on the laser light sources depending on purposes.

9. The laser recording device according to claim 8, wherein the laser light sources include color development laser light sources each assigned to one of the at least one color development layer.

10. The laser recording device according to claim 9, wherein the color development laser light sources are set to different rated outputs for the respective color development layers assigned.

11. The laser recording device according to claim 8, wherein the laser light sources include a preheating laser light source, and the recording control includes preheating the thermal recording medium with laser light from the preheating laser light source.

12. The laser recording device according to claim 8, wherein
the laser light sources include a visible light laser light source for an irradiation start position marker, and
the recording control includes marking an irradiation start position with laser light from the visible light laser light source.

13. The laser recording device according to claim 1, wherein the recording controller is configured to change a control parameter based on recording data of a plurality of pixels arranged before and after a recording pixel in the control for causing the laser light sources to emit light independently of each other.

14. The laser recording device according to claim 1,
wherein the recording controller is configured to perform laser light irradiation for preheating the thermal recording medium prior to laser light irradiation for recording information on the thermal recording medium in the control for causing the light sources to emit light independently of each other,
wherein the laser light irradiation for preheating is performed with a spot diameter larger than a spot diameter of the laser light irradiation for recording.

15. The laser recording device according to claim 1, wherein the recording controller is configured to control the laser light sources such that laser light is not simultaneously emitted from adjacent emitters among the emitters.
